(19) United States
(12) Patent Application Publication
(10) Pub. No.: US 2009/0243963 A1
(43) Pub. Date: Oct. 1, 2009

(54) IMAGE DISPLAY APPARATUS AND METHOD FOR DISPLAYING AN IMAGE

(75) Inventors: Aira Hotta, Tokyo (JP); Takashi Sasaki, Yokohama-shi (JP); Haruhiko Okumura, Fujisawa-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/408,857

(22) Filed: Mar. 23, 2009

(30) Foreign Application Priority Data
Mar. 28, 2008 (JP) P2008-088159

(51) Int. Cl. G09G 5/00

(52) U.S. Cl. 345/7

(57) ABSTRACT

An image display apparatus includes: an imaging device inputting sequentially information of an observer; a position calculation unit calculating positions of a single eye of the observer from the information sequentially; a difference calculation unit calculating a difference between the position of the single eye calculated at a present time and a previous time; a projection position determination unit determining a target value of a projection position of a light beam on the single eye from the difference; and a projector presenting an image to the observer by projecting the light beam to the projection position.

### CROSS REFERENCE TO RELATED APPLICATIONS AND INCORPORATED BY REFERENCE

The application is based upon and claims the benefit of priority from the prior Japanese Patent Applications No. P2008-088159, filed on Mar. 28, 2008; the entire contents of which are incorporated herein by reference.

### BACKGROUND OF THE INVENTION

1. Field of the Invention

The present invention relates to an in-vehicle image display apparatus and a method for displaying an in-vehicle image.

2. Description of the Related Art

A head-up display (HUD) has been developed as an in-vehicle image display apparatus. The HUD shows travel information including vehicle speed and route information to a destination by projecting such information onto a windshield to superimpose the same on outside (exterior) information observed through the windshield. With a normal HUD, an image is observed by both eyes. On the other hand, for the purpose of increasing visibility and the like, a monocle HUD, with which an image is observed by a single eye, has been proposed.

As an example of the monocle HUD, there is a proposed technique to present an image to only a single eye to prevent a double image due to binocular observation (JP-A 7-228172). Moreover, another technique to present an image only to a single eye has been developed to eliminate binocular disparity and enhance depth perception.

In the monocle HUD, the range of a light beam projected on a single eye is controlled to that which the single eye can see by a lenticular screen provided in an optical projection system. If the head of an observer (driver) moves, the range of the projected light beam deviates from the position of the single eye, and the observer cannot see the image. To prevent such a situation, the monocle HUD is provided with a head tracking mechanism so that the projection position of the light beam moves and tracks the head of the observer using a movable mirror.

In the conventional head tracking mechanism, the projection position of the light beam is moved so that the position of the single eye coincides with the center of the projection range of the light beam. However, there is a time lag between the movement of the single eye and the movement of the projection position of the light beam. In some cases, the projection position of the light beam is deviated from the position of the single eye, thus making it impossible for the observer to see the image. In other cases, the light beam is projected on a different single eye from the single eye onto which the light beam had previously been projected, thus making it difficult for the observer to see the image.

### SUMMARY OF THE INVENTION

An object of the present invention is to provide an image display apparatus and a method for displaying an image, which can provide better viewing of images for an observer by tracking a position of an eye.

An aspect of the present invention inheres in an image display apparatus including: an input device configured to input sequentially information of an observer; a position calculation unit configured to calculate positions of a single eye of the observer from the information; a difference calculation unit configured to calculate a difference between the position of the single eye calculated at a present time and the position of the single eye calculated at a previous time; a projection position determination unit configured to determine a target value of a projection position of a light beam on the single eye from the difference so as to track the position of the single eye; and a projector configured to present an image to the observer by projecting the light beam to the projection position.

Another aspect of the present invention inheres in a method for displaying an image, including: inputting information of an observer sequentially; calculating sequential positions of a single eye of the observer from the information; calculating a difference between the position of the single eye calculated at a present time and the position of the single eye calculated at a previous time; determining a target value of a projection position of a light beam on the single eye from the difference so as to track the position of the single eye; and presenting an image to the observer by projecting the light beam to the projection position.

### BRIEF DESCRIPTION OF DRAWINGS

FIG. 1 is a block diagram showing an example of an image display apparatus (monocle HUD) according to the embodiment of the present invention.

FIG. 2 is a schematic view showing an example of displaying images according to the embodiment of the present invention the image display apparatus.

FIG. 3 is a schematic view for explaining a method for detecting a single eye according to the embodiment of the present invention.

FIG. 4 is a graph showing a relationship between a viewing position and a position coordinates of the single eye according to the embodiment of the present invention.

FIG. 5 is a graph showing a relationship between a position of a single eye and a projection position of a light beam according to the embodiment of the present invention.

FIGS. 6A to 6C are schematic views for explaining tracking the single eye according to the embodiment of the present invention.

FIG. 7 is a flowchart for explaining an example of a method for displaying an image according to the embodiment of the present invention.

FIG. 8 is a flowchart for explaining an example of a method for detecting the single eye according to the embodiment of the present invention.

FIG. 9 is a flowchart for explaining an example of a method for determining the projection position according to the embodiment of the present invention.

FIG. 10 is a block diagram showing an example of the image display apparatus according to the first modification of the present invention.

FIGS. 11A to 11E are schematic views for explaining moving the projection position according to the embodiment of the present invention.

FIGS. 12A to 12E are schematic views for explaining a distortions of images by moving projection positions according to the embodiment of the present invention.

FIGS. 13A to 13D are schematic views for explaining correcting the distortions of the images according to the embodiment of the present invention.

FIG. 14 is a schematic view for explaining a relationship between a rotating position of a motor and a position of a center of an image according to the first modification of the present invention.

FIG. 15 is a graph showing a relationship between a viewing point and a rotating angle of the motor according to the first modification of the present invention.

FIG. 16 is a flowchart showing an example of a method for correcting a distortion by the image display apparatus according to the first modification of the present invention.

FIG. 17 is a block diagram showing an example of the image display apparatus according to the second modification of the present invention.

FIG. 18 is a schematic view showing an example of displaying superimposition on an outside by the image display apparatus according to the second modification of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Generally and as it is conventional in the representation of semiconductor devices, it will be appreciated that the various drawings are not drawn to scale from one figure to another nor inside a given figure, and in particular that the layer thicknesses are arbitrarily drawn for facilitating the reading of the drawings.

In the following descriptions, numerous specific details are set fourth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

As an image display apparatus according to an embodiment of the present invention, an in-vehicle monocle HUD will be described. The image display apparatus according to the embodiment of the present invention includes a CPU 1, a memory 2, an imaging device (input device) 3, and projector 4.

The projector 4 projects a light beam 100 onto a single eye 102 of an observer 101 to present an image to the observer 101. The projector 4 includes a light beam generator 40, a projection lens 41, a projection range controller 42, a projection position controller 43, an image magnifier 44, a drive unit 45, and a reflection member 50.

The light beam generator 40 generates the light beam 100 that forms an image to present travel information such as vehicle speed, route information to a destination, or the like to the observer 101 as an image. Examples of the light beam generator 40 are a liquid crystal panel, a digital micro-mirror device (DMD) panel including micro-mirrors, and a LED projector. The light beam generator 40 includes a light source such as an LED or a high pressure mercury lamp for projecting an image. Using LEDs as the light source can reduce the size of the apparatus and power consumption.

The projection lens 41 projects the light beam 100 generated by the light beam generator 40. The projection range controller 42 may be a lenticular screen, a diffuser with a diffusion angle controller or the like. The lenticular screen can have, for example, a numeric aperture (NA) of 0.03 on an incoming side and a numeric aperture (NA) of 0.1 on an outgoing side but is not limited any particular NA. The projection range controller 42 controls the range of the light beam 100 by controlling the divergence angle of the light beam 100. Herein, the horizontal width of the light beam 100 is preferably controlled to be not more than about 6 cm. This allows the light beam 100 to be projected onto only a single eye 102 of the observer 101 because the distance between the eyes is about 6 cm on average.

The projection position controller 43 can be a movable mirror comprising a combination of a rotating stage and a mirror. The projection position controller 43 controls the projection position of the light beam 100 by adjusting the angle of the movable mirror to control the direction of the light beam 100. The projection position controller 43 is connected to the drive unit 45. The drive unit 45 can be a motor or the like. The drive unit 45 drives the projection position controller 43 based on a control signal from the CPU 1. The image magnifying unit 44 can be a projection lens or the like. The image magnifying unit 44 magnifies an image formed by the light beam 100 to a predetermined size.

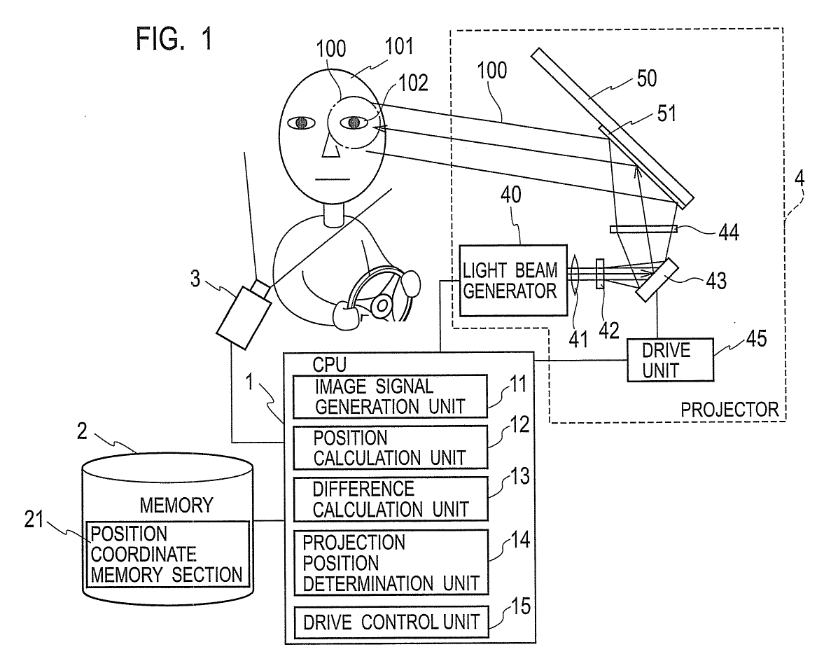

The reflection member 50 reflects the light beam 100 from the image magnifying unit 44. The reflection member 50 can be a semi-transparent spherical concave mirror with controlled reflectivity, such as a windshield. In addition to the windshield, the reflection member 50 can be a member including a combination of effects of a projection lens and a windshield, a movable concave mirror including the function of a projection lens and a movable mirror, or the like. By adjusting the curvature of the concave mirror, the visual field of the image that the observer 101 sees can be changed. As shown in FIG. 1, the reflection member 50 may be provided with a highly reflective sheet 51 having a higher reflectivity than that of the reflection member 50. Since the reflection member 50 is semi-transparent, the observer 101 can see the landscape ahead through the reflection member 50.

In an image display apparatus according to the embodiment of the present invention, the light beam 100 generated by the light beam generator 40 passes through the projection lens 41 to the projection range controller 42, and is controlled thereby. Furthermore, the projection position of the light beam 100 is controlled by the projection position controller 43. The image formed by the light beam 100 is magnified by the image magnifying unit 44 to a desired size. Thereafter, the light beam 100 is reflected by the reflection member 50 and is incident on an eye of the observer 101 to view the image.

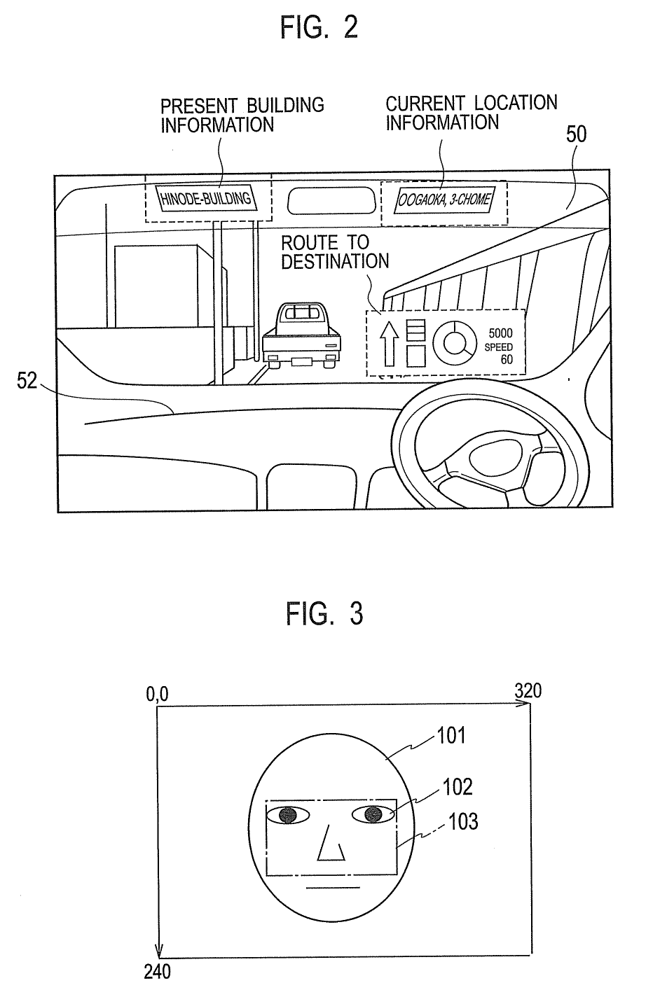

As a result, as shown in FIG. 2, it is possible to present building information, a route to a destination, current location information, an the like to the observer 101 as an image which is superimposed on the background transmitted through the refection member 50. As shown in FIG. 2, the CPU 1, memory 2, imaging device 3, part of the projector 4 other than the refection member 50, and the like are incorporated in a dashboard 52 of a vehicle.

The imaging device 3 shown in FIG. 1 sequentially captures images (input information) to be viewed by the observer 101. The imaging device 3 can be a camera or the like.

The CPU 1 includes modules (logic circuits) which are hardware resources. The modules include: an image signal generation unit 11; a position calculation unit 12; a difference calculation unit 13; a projection position determination unit 14; and a drive control unit 15. The image signal generation unit 11 generates an image signal allowing the light beam generator 40 to generate an image. The position calculation unit 12 sequentially calculates the position of the single eye 102 from the image captured by the imaging device 3. The difference calculation unit 13 calculates a difference between a position of the single eye 102 detected in a current frame and a position of the single eye 102 detected in a previous frame. The projection position determination unit 14 determines the projection position of the light beam 100 from the difference. Based on the determined projection position of the light beam 100, the drive control unit 15 outputs a control signal to the drive unit 45. The CPU 1 may be connected to an input unit, an output device, and the like as needed.

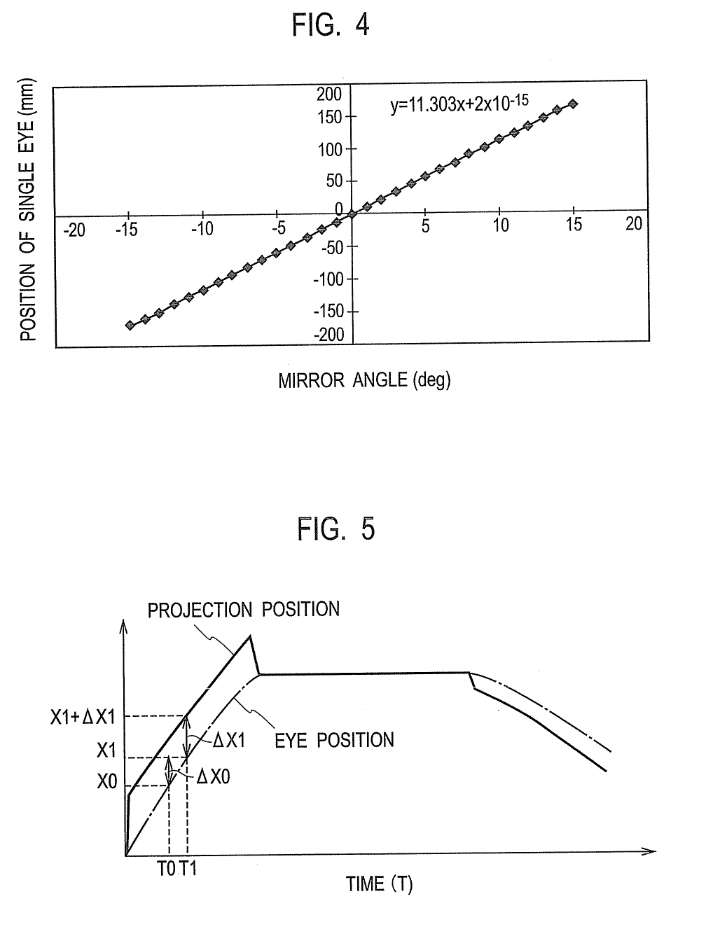

As shown in FIG. 3, the position calculation unit 12 detects a face 103 from the image captured by the imaging device 3, then detects a single eye 102 as a feature of the face 103, and plots pixel positions of the image on coordinates to calculate the position coordinate of the eye 102. In the embodiment of the present invention, as shown in FIG. 4, the angular coordinate of the projection position controller 43 and a position coordinate y of the single eye 102 have a substantially linear relationship.

FIG. 5 shows a relationship between the position of a single eye 102 and the projection position of the light beam 100 on the eye 102. Herein, time T1 indicates the current time. As shown in FIG. 5, the difference calculation unit 13 reads a position X1 of a single eye 102 detected in a current frame at the time T1 from the position coordinate memory section 21 of the memory 2 and a position X0 of the single eye 102 detected in a previous frame at time T0. The difference calculation unit 13 then calculates a difference (a displacement of the single eye 102) ΔX0 between the position X1 of the eye 102 detected in the current frame and the position X0 of the eye 102 detected in the previous frame.

The projection position determination unit 14 determines a target value X1+ΔX1 of the projection position of the light beam 100 from the difference ΔX0 calculated by the difference calculation unit 13. Herein, the projection position determination unit 14 determines the presence of the difference ΔX0, for example, whether ΔX0 is less than a predetermined threshold (absence) or not less than the predetermined threshold (presence). When ΔX0 is present, the projection position determination unit 14 recognizes that the position of the eye 102 has moved. In this case, the eye 102 is predicted to keep moving after the time T1 in a direction that the eye 102 moves between the time T0 and time T1, and the target value X1+ΔX1 of the projection position of the light beam 100 is set to a position the distance ΔX1 away from the position X1 of the single eye 102, which is detected in the current frame, in the direction that the eye 102 moves between the time T0 and time T1. The predetermined threshold value should be previously stored in the memory 2, for example.

At this time, it is preferable that the projection determination unit 14 changes the distance ΔX1 according to the difference ΔX0. For example, as the difference ΔX0 is larger (the displacement of the eye 102 is larger), the projection determination unit 14 increases the distance ΔX1 to determine the target value X1+ΔX1 of the projection position of the light beam 100. The distance ΔX1 may be set to the same value as the difference ΔX0, for example, and can be properly set depending on the types and performances of the CPU 1, memory 2, imaging device 3, and projector 4.

The projection position determination unit 14 recognizes that the position of the single eye 102 has not moved when the difference ΔX0 is not present or is less than the predetermined threshold value. In this case, the target value X1 of the projection position of the light beam 100 is determined so that the position of the eye 102 coincides with the center of the projection range of the light beam 100.

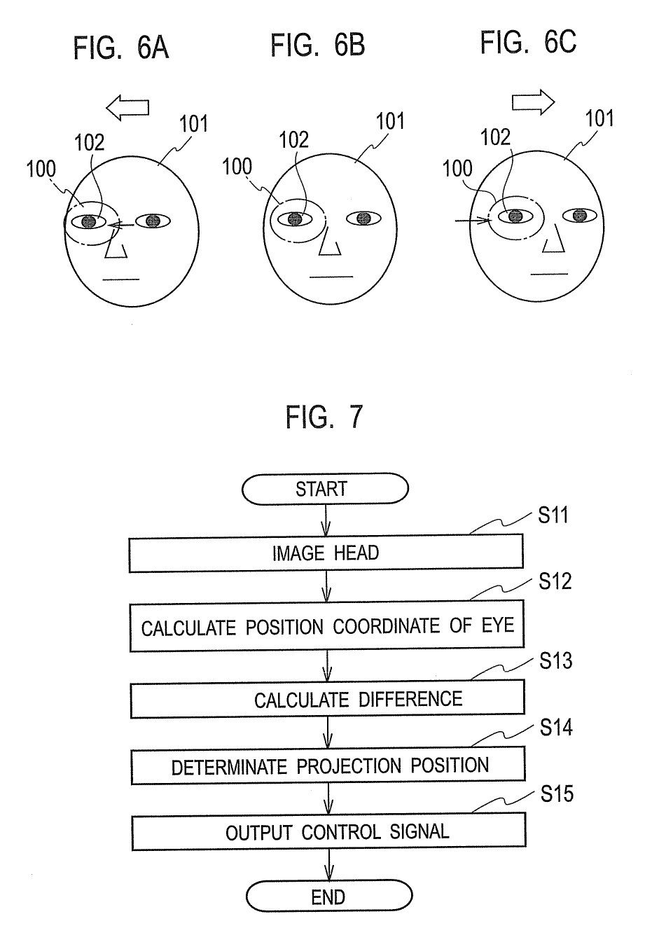

FIG. 6A shows head moving; FIG. 6B shows the head movement has stopped; and FIG. 6C shows head moving in the opposite direction to the direction that the head is moving in FIG. 6A. As shown in FIGS. 6A to 6C, determining the projection position of the light beam 100 according to the difference ΔX0 allows the projection position of the light beam 100 to track the position of the eye 102.

Furthermore, the projection position determination unit 14 preferably projects the light beam 100 onto a dominant eye of the observer 101 for the best view of the image. For example, the information on the dominant eye of the observer 101 should be previously set in the memory 2, and the projection position determination unit 14 determines the projection position of the light beam 100 based on the set information on the dominant eye of the observer 101.

When it is better that the light beam 100 is projected onto the non-dominant eye depending on the external situations, displayed information, and observer situations, the projection position determination unit 14 should change the eye on which the light beam is projected by controlling the angle of the projection position controller 43.

The drive control unit 15 outputs the control signal to the drive unit 45 so that the light beam 100 is projected onto the projection position of the light beam 100 determined by the projection position determination unit 14 and controls the drive unit 45 to adjust the angle of the projection position controller 43.

The memory 2 includes a position coordinate memory section 21 chronologically storing the position coordinates of the eye 102 calculated by a position coordinate calculation unit. A semiconductor memory, a magnetic disk, an optical disk, a magneto-optical disk, a magnetic tape or the like may be used for the memory 2. For the semiconductor memory, a ROM and RAM may be used. The ROM stores a program executed by the CPU 1 (the details of the program are described later). The RAM serves as a temporary data memory for storing data used in executing a program by the CPU 1, and used as a working domain.

### (Method for Displaying an Image)

Next, an example of an image display method according to the embodiment of the present invention will be described with reference to a flowchart shown in FIG. 7.

In step S11, the imaging device 3 continuously captures the observer 101.

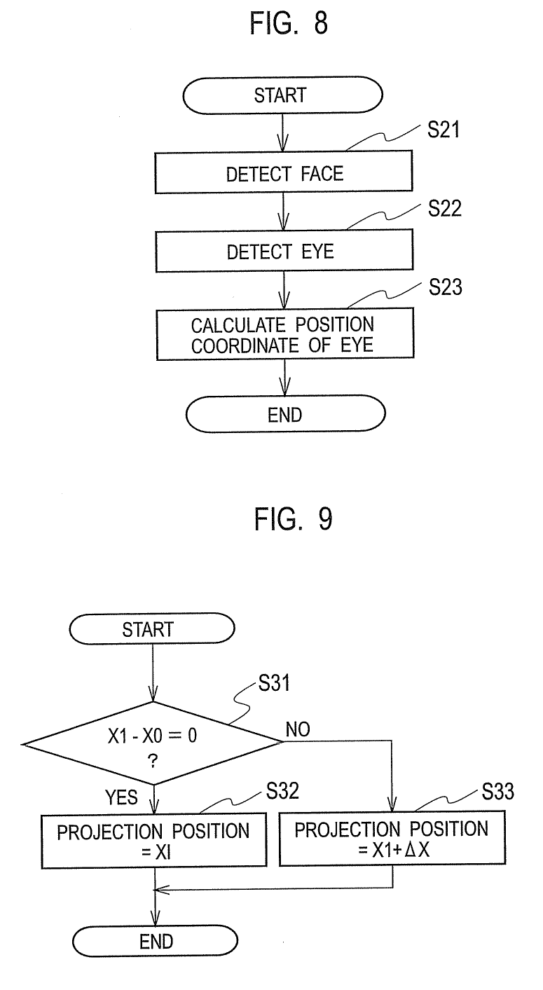

In step S12, the position calculation unit 12 sequentially calculates the position of a single eye 102 of the observer from the image captured by the imaging device 3. First, in step S21 of FIG. 8, the face 103 of the observer 101 is detected from the image captured by the imaging device 3. In step S22, a single eye 102 is detected as the feature of the face 103. In step S23, the pixel positions of the eye 102 on the image are plotted on coordinates to calculate the position coordinate of the eye 102. The calculated position coordinate of the eye 102 is stored in the position coordinate memory section 21.

In step S13 of FIG. 7, as shown in FIG. 5, the difference calculation unit 13 reads, from the position coordinate memory section 21, the position X1 of the eye 102 calculated in the current frame and the position X0 of the eye 102 calculated in the previous frame and calculates the difference ΔX0 between the position X1 of the eye 102 calculated in the current frame and the position X0 of the eye 102 calculated in the previous frame.

In step S14, the projection position determination unit 14 determines the projection position of the light beam 100 from the difference ΔX0 calculated by the difference calculation unit 13. First, in step S31 of FIG. 9, it is determined whether the difference ΔX0 calculated by the difference calculation unit 13 is not less than the predetermined threshold. Herein, the predetermined threshold is set to 0 for determining the presence of the difference ΔX0. When the difference ΔX0 is determined as not being present, the process proceeds to step S32, and the target value X1 of the projection position of the light beam 100 is determined so that the position X1 of the eye 102 coincides with the center of the projection range of the light beam 100. On the other hand, when the difference ΔX0 is present in step S31, the process proceeds to step S33, and the target value X1+ΔX1 of the projection position of the light beam 100 is determined to be spaced from the position X1 of the eye 102 currently detected in the direction that the position of the eye 102 moves between the time T0 and time T1.

In step S15 of FIG. 7, the drive control unit 15 outputs a control signal to the drive unit 45 (a motor) so that the projection position of the light beam 100 is located at the position determined by the projection position determination unit 14. The drive unit 45 controls the angle of the projection position controller 43 based on the control signal output by the drive control unit 15. The light beam 100 generated by the light beam generator 40 for forming an image is projected on the projection position of the light beam 100 sequentially determined by the projection position determination unit 14.

According to the image display apparatus and image display method according to the embodiment of the present invention, the projection position of the light beam 100 is determined according to the difference ΔX0 between the position X1 of an eye 102 detected in the current frame and the position X0 of the eye 102 detected in the previous frame. Accordingly, the projection position of the light beam 100 can be properly moved to track the movement of the eye 102. It is therefore possible to prevent the light beam 100 from deviating from the position of a specific eye 102 and provide better viewing of images for the observer 101.

### (Program)

The series of procedures shown in FIG. 7 can be achieved by controlling the image display apparatus shown in FIG. 1 by means of a program having an algorism equivalent to that of FIG. 7. The procedures shown in FIG. 7 include: the step of calculating the position of a single eye 102 captured by the imaging device 3 sequentially; the step of calculating the difference ΔX0 between the position of the eye 102 calculated in the current frame and the position of the eye 102 calculated in the previous frame; and the step of determining the projection position of the light beam 100 from the difference ΔX0.

The program may be stored in the memory 2 of the image display apparatus according to the embodiment of the present invention. The program can be stored in a computer-readable storage medium. The procedures of the method according to the embodiment of the present invention can be performed by reading the program from the computer-readable storage medium to the data memory 2.

Here, the “computer-readable storage medium” means any media and the like that can store a program include, e.g., external memory units, semiconductor memories, magnetic disks, optical disks, magneto-optical disks, magnetic tape, and the like for a computer. To be more specific, the “computer-readable storage media” include magnetic disks, optical disk, and the like. For example, the main body of the image display apparatus can be configured to incorporate a magnetic disk drive and an optical disk drive, or to be externally connected thereto. A magnetic disk is loaded to the magnetic disk drive, an optical disk is inserted into the optical disk drive, and then a given readout operation is executed, whereby programs stored in these storage media can be installed on the memory 2. In addition, by connecting given drives to the image display apparatus, it is also possible to use, for example, a ROM as a memory unit employed for a EEPROM module or the like. Furthermore, it is possible to store a program in another program storage device via an information processing network, such as the Internet.

### (First Modification)

In the embodiment of the present invention, the direction of the light beam 100 is changed by the projection position controller 43 for tracking the position of a single eye 102. This creates distortion and displacement in the image presented to the observer 101. As a first modification of the embodiment of the present invention, an example including distortion and displacement correction will be described.

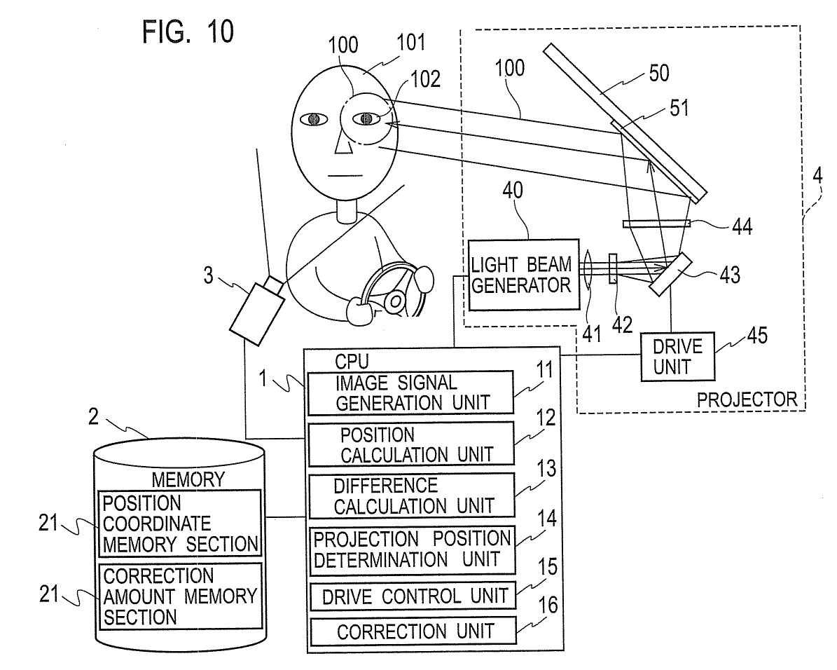

The image display apparatus according to the first modification of the embodiment of the present invention is different from that shown in FIG. 1 in that, as shown in FIG. 10, the image display apparatus further includes a correction memory section 22 in the memory 2 and the CPU 1 further includes a correction unit 16 for determining an amount of correction to avoid distortion. The correction memory section 22 stores data to correct distortion, size, and displacement of an image. The correction unit 16 corrects the distortion and displacement of an image caused by a change of the projection position of the light beam 100.

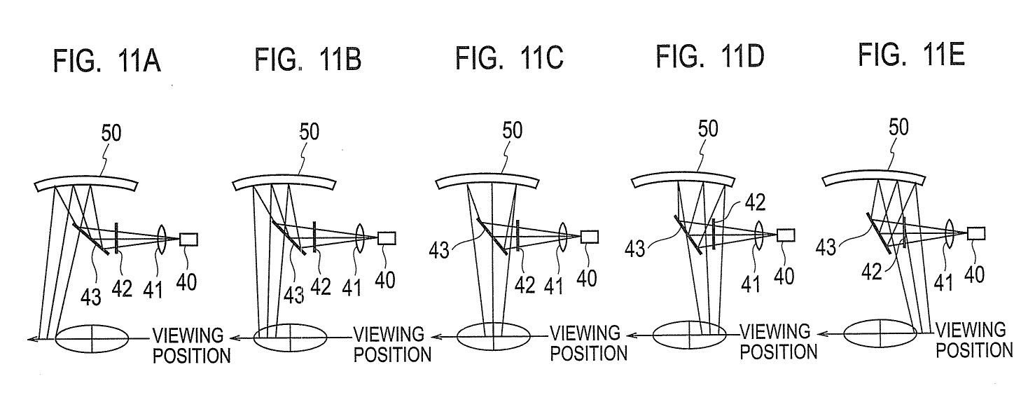

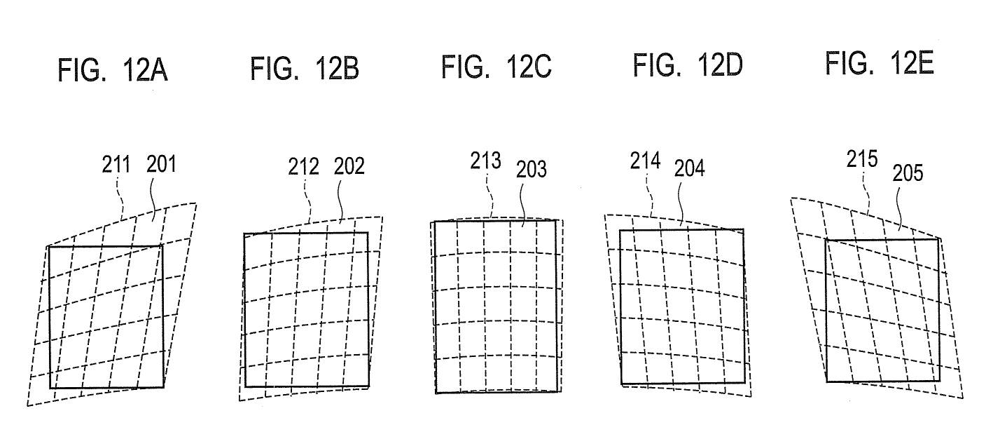

FIGS. 11A to 11E respectively show the light beam 100 when the position of the projection position controller (movable mirror) 43 is located as follows: 10 degrees to the left; 5 degrees to the left; at the center; 5 degrees to the right; and 10 degrees to the right. FIGS. 12A to 12E show examples of images observed by the observer 101 corresponding to FIGS. 11A to 11E, respectively.

When the projection position controller 43 is located at the center position as shown in FIG. 11C, an actual image 211 is substantially equal to a desired image 201 as shown in FIG. 12C. On the other hand, when the projection position controller 43 is rotated as shown in FIGS. 11A, 11B, 11D, and 11E, actual images 211, 212, 214, and 215 look distorted with respect to desired images 201, 202, 204, and 205 as shown in FIGS. 12A, 12B, 12D and 12E, respectively.

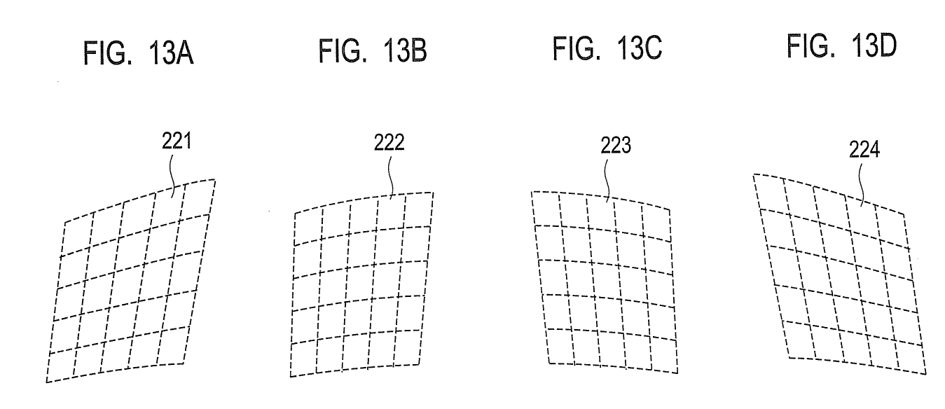

The correction unit 16 generates an image signal correcting distortion of the images 211, 212, 214, and 215 using a correction amount read from the correction amount memory section 22 based on the rotational position of the projection position controller 43 and the position coordinate of the single eye 102 read from the position coordinate memory section 21. The light beam generator 40 generates an image from the image signal with the distortion corrected. As shown in FIGS. 13A to 13D, it is therefore possible to generate images 221 to 224 subjected to correction according to the distortion when the projection position controller 43 is rotated as shown in FIGS. 12A, 12B, 12D, and 12E, respectively.

When the projection position controller 43 is rotated, the images change in size as well as being distorted. The correction unit 16 generates an image signal including correction information on size of the image using the correction amount read from the correction amount memory section 22 based on the rotational position of the projection position controller 43 and the position coordinate of the eye 102 read from the position coordinate memory section 21.

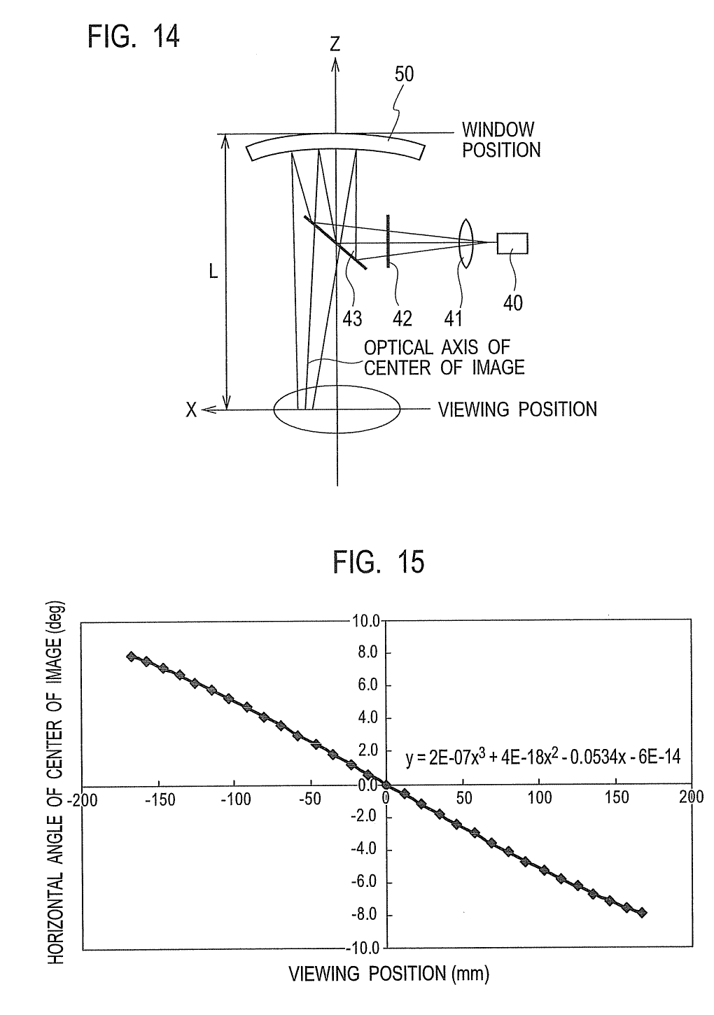

As shown in FIG. 14, the distance between the reflection member 50 and the viewing position, the viewing position, and horizontal angle of the center of an image (center-of-image horizontal angle) are indicated by L, x, and y, respectively. The center-of-image horizontal angle y changes as shown in FIG. 15 according to the viewing position x, and the angle at which the image is observed changes as the projection position of the light beam 100 moves. The correction unit 16 generates an image signal including correction information on displacement of the image using the correction amount read from the correction amount memory section 22 based on the rotational position of the projection position controller 43 and the position coordinate of the eye 102 read from the position coordinate memory section 21.

The light beam generator 40 generates a light beam forming an image based on the image signal corrected by the correction unit 16.

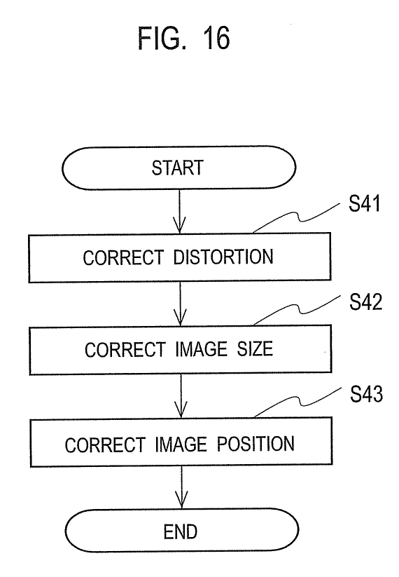

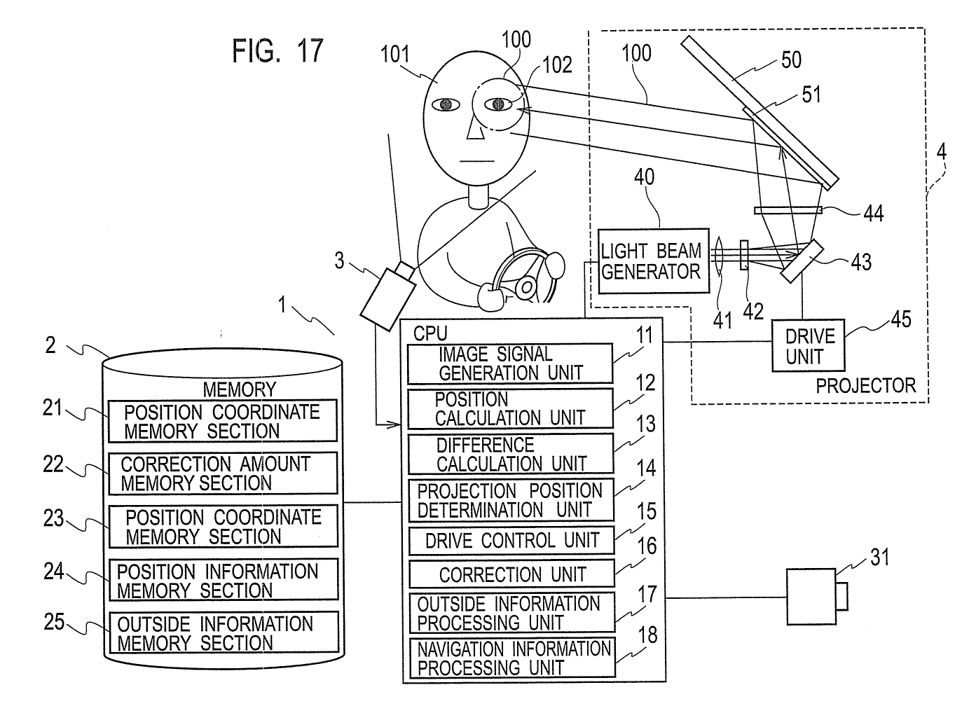

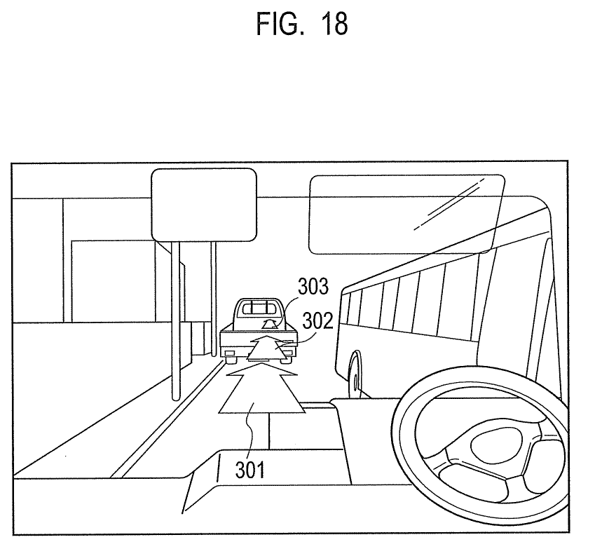

In the image display method according to the first modification of the embodiment of the present invention, after the projection position of the light beam 100 is determined in the step S14 of FIG. 7, the projection position controller 43 is rotated in step S15. Simultaneously, as shown in FIG. 16, in steps S41, S42, and S43, the image signal which forms an image with corrected distortion, size, and displacement using the correction amounts read from the correction amount memory unit 22 based on the rotational position of the projection position controller 43 and the position coordinate of the eye 102 read from the position coordinate memory section 21. The light beam generator 40 generates a light beam forming an image based on the image signal corrected by the correction unit 16.

According to the first modification of the embodiment of the present invention, image distortion and displacement caused by tracking the eye position are corrected, thus making it possible to present natural and easy-to-see images to the observer 101.

### (Second Modification)

As a second modification of the embodiment of the present invention, a system which has a navigation function and superimposes information on an outside view will be described. The system is different from the image display apparatus shown in FIG. 14 as further including an outside information acquisition device 31.

The outside information acquisition device 31 acquires outside information. The outside information acquisition device 31 can be a camera or the like.

The memory 2 further includes: a map information memory section 23 storing map information; a position information memory section 24 storing position information; and an outside information memory section 25 storing the outside information acquired by the outside information acquisition device 31.

The CPU 1 further includes an outside information processing unit 17 and a navigation information processing unit 18. The outside information processing unit 17 detects road information from the information acquired by the outside information acquisition device 31 and controls the position of the presented image so that the presented image is superimposed on the road viewed through the reflection member 50 as shown in FIG. 18.

The navigation information processing unit 18 reads the position information and map information from the position information memory section 24 and the map information memory section 23, respectively, and generates images 301 to 303 showing a route to the destination as shown in FIG. 18.

According to the second modification of the embodiment of the present invention, images are superimposed on the landscape viewed through the reflection member 50, thus allowing the observer 101 to acquire information looking in the direction where the observer (driver) is going without looking down. It is therefore possible to provide a safe and easy-to-see display.

### Other Embodiments

Various modifications will become possible for those skilled in the art after receiving the teachings of the present disclosure without departing from the scope thereof.

In the above description of the embodiment of the present invention, the imaging device 3 is the camera. The imaging device 3 is not limited to the camera. The image display apparatus is having a position sensor instead of the camera, wherein the position senor is detecting a head position of the observer. The position calculation unit 12 sequentially calculates the position of the single eye 102 from the position detected by the position sensor.

In the above description of the embodiment of the present invention, the image display apparatus is an in-vehicle monocle HUD. The applications of the image display apparatus are not limited to vehicles, and it is obvious that the image display apparatus can be applied to ships, airplanes, machine tools, construction machines, industrial machines, and the like.

What is claimed is:

1. An image display apparatus comprising:
an input device configured to input sequentially information of an observer;
a position calculation unit configured to calculate positions of a single eye of the observer from the information;
a difference calculation unit configured to calculate a difference between the position of the single eye calculated at a present time and the position of the single eye calculated at a previous time;
a projection position determination unit configured to determine a target value of a projection position of a light beam on the single eye from the difference so as to track the position of the single eye; and
a projector configured to present an image to the observer by projecting the light beam to the projection position.

2. The apparatus of claim 1, wherein the projection position determination unit determines whether the difference is not less than a predetermined value,
the projection position determination unit determines the target value to a position spaced from the position of the single eye calculated at the present time in a direction in which the position of the single eye moves, when the difference is determined to be not less than the predetermined value.

3. The apparatus of claim 1, wherein the projection position determination unit determines the target value so that the position of the single eye calculated at the present time with a center of a range of the light beam coincides, when the difference is determined to be less than the predetermined value.

4. The apparatus of claim 1, wherein the projector comprises:
a light beam generator configured to generate the light beam;
a projection range controller configured to control a projection range of the light beam by controlling a divergence angle of the light beam;
a projection position controller configured to control the projection position by controlling a direction of the light beam; and
a reflection member configured to reflect the light beam.

5. The apparatus of claim 1, wherein the projection position determination unit changes the target value in accordance with the difference.

6. The apparatus of claim 1, further comprising a correction unit configured to correct distortion of the image created by a change in the target value.

7. The apparatus of claim 1, wherein the horizontal width of the light beam is controlled to be not more than 6 cm.

8. A method for displaying an image, comprising:
inputting information of an observer sequentially;
calculating sequential positions of a single eye of the observer from the information;
calculating a difference between the position of the single eye calculated at a present time and the position of the single eye calculated at a previous time;
determining a target value of a projection position of a light beam on the single eye from the difference so as to track the position of the single eye; and
presenting an image to the observer by projecting the light beam to the projection position.

9. The method of claim 8, wherein determining the target value comprises:
determining whether the difference is not less than a predetermined value; and
determining the target value to a position spaced from the position of the single eye calculated at the present time in a direction in which the position of the single eye moves, when the difference is determined to be not less than the predetermined value.

10. The method of claim 8, wherein determining the target value comprises:
determining the target value so that the position of the single eye calculated at the present time with a center of a range of the light beam coincides, when the difference is determined to be less than the predetermined value.

11. The method of claim 8, wherein presenting the image to the observer comprises:
generating the light beam;
controlling a projection range of the light beam by controlling a divergence angle of the light beam;
controlling the projection position by controlling a direction of the light beam; and
reflecting the light beam.

12. The method of claim 8, wherein determining the target value comprises changing the target value in accordance with the difference.

13. The method of claim 8, further comprising: correcting distortion of the image created by a change in the target value.

14. The method of claim 8, further comprising controlling the horizontal width of the light beam to be not more than 6 cm.
